(19) United States
(12) Patent Application Publication
(10) Pub. No.: US 2019/0344881 A1
(43) Pub. Date: Nov. 14, 2019

(54) MULTIPLE DEGREE OF FREEDOM VIBRATION SUPRESSION SYSTEM FOR CONTROLLING VIBRATIONS INDUCED BY A MAIN ROTOR WAKE ON TAILS SURFACES OF A ROTARY WING AIRCRAFT

(71) Applicant: Sikorsky Aircraft Corporation, Stratford, CT (US)

(72) Inventors: Michael Robert Monico, Hamden, CT (US); William A. Welsh, North Haven, CT (US)

(21) Appl. No.: 15/977,821

(22) Filed: May 11, 2018

(51) Int. Cl. B64C 27/00; F16F 15/22; G05D 19/02

(52) U.S. Cl. CPC B64C 27/001; B64C 2027/004; G05D 19/02; F16F 15/22

(57) ABSTRACT

A vibration suppression system for a rotorcraft having an airframe, a main gear box, a rotor, a hub, a rotor head, and an extending tail including a vertical stabilizer and a stabilator, the vibration suppression system includes one or more active vibration control actuators (AVC) mounted in the extending tail within a vibration affected zone. The vibration affected zone being between about 0% to about 20% of a length of the extending tail measured from a trailing edge of the vertical stabilizer.

### STATEMENT OF FEDERAL SUPPORT

This invention was made with government support under Agreement No. W911W6-12-2-0005 awarded by the Army. The Government has certain rights in the invention.

### BACKGROUND

The subject matter disclosed herein generally relates to the art of air vehicles and, more particularly, to a multiple degree of freedom vibration suppression system for controlling vibrations induced by a main rotor wake on tail surfaces of a rotary wing aircraft.

Vibration systems for current production rotorcraft (e.g., helicopters) do not nullify vibration produced by wakes passing from a rotor blade onto aircraft surfaces. Most vibratory loads enter an airframe of the rotorcraft through a main rotor system. Forces and moments produced by rotor blades, gearbox, transmission housing and the like directly enter into the airframe. Additional vibratory loads enter the airframe indirectly. For example, rotor wake may induce vibratory loads on a tail section of the rotorcraft due to aerodynamic effects. Placing active vibration actuators at or near a main gear box or other surface near cabin spaces does not address vibrations that may be produced more remotely from the rotor system itself. As a consequence, there is a need to find a way to mount effective vibration suppression actuators that will address vibratory loads produced by the aerodynamic effects.

### BRIEF DESCRIPTION

According to an exemplary embodiment, a vibration suppression system for a rotorcraft having an airframe, a main gear box, a rotor, a hub, a rotor head, and an extending tail including a vertical stabilizer and a stabilator, the vibration suppression system includes one or more active vibration control actuators (AVC) mounted in the extending tail within a vibration affected zone. The vibration affected zone being between about 0% to about 20% of a length of the extending tail measured from a trailing edge of the vertical stabilizer.

In addition to one or more of the features described above, or as an alternative, in further embodiments the vibration affected zone is within about 0% to about 15% of the length of the extending tail measured from the trailing edge of the vertical stabilizer.

In addition to one or more of the features described above, or as an alternative, in further embodiments the rotorcraft includes a wheel mounted to the extending tail, vibration affected zone extends from the trailing edge to substantially vertically above the wheel.

In addition to one or more of the features described above, or as an alternative, in further embodiments a first one of the one or more active vibration control actuators is mounted to a first side of the extending tail vertically above the wheel and a second one of the one or more active vibration control actuators is mounted to a second, opposing side of the extending tail vertically above the wheel.

In addition to one or more of the features described above, or as an alternative, in further embodiments at least one of the one or more AVC actuators is mounted to one of the vertical stabilizer and the stabilator.

In addition to one or more of the features described above, or as an alternative, in further embodiments a hub mounted vibration suppressor (HMVS) mounted on the rotor head to reduce in-plane loads that the rotor exerts on the hub.

In addition to one or more of the features described above, or as an alternative, in further embodiments the HMVS includes a plurality of hub actuators.

In addition to one or more of the features described above, or as an alternative, in further embodiments a plurality of sensors for providing feedback to the plurality of hub actuators and the one or more active vibration control actuators.

In addition to one or more of the features described above, or as an alternative, in further embodiments each of the plurality of sensors are mounted in a fuselage of the airframe.

In addition to one or more of the features described above, or as an alternative, in further embodiments each of the plurality of sensors are accelerometers.

In addition to one or more of the features described above, or as an alternative, in further embodiments the HMVS includes HMVS sensors operationally independent of the plurality of sensors.

In addition to one or more of the features described above, or as an alternative, in further embodiments a controller providing coordinated control information to both the HMVS and the one or more AVC actuators to reduce vibration.

In addition to one or more of the features described above, or as an alternative, in further embodiments the HMVS includes an HMVS controller operational independent of the controller.

According to another exemplary embodiment, an aircraft includes an airframe, a main gear box, a rotor including a hub and a rotor head, an extending tail including a vertical stabilizer and a stabilator, and one or more active vibration control (AVC) actuators mounted in the extending tail within a vibration affected zone. The vibration affected zone being between about 0% to about 20% of a length of the extending tail measured from a trailing edge of the vertical stabilizer.

In addition to one or more of the features described above, or as an alternative, in further embodiments the vibration affected zone is within about 0% to about 15% of the length of the extending tail measured from the trailing edge of the vertical stabilizer.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

The subject matter disclosed herein is particularly

FIG. 1 depicts a side view of a rotary wing aircraft including an n/rev vibration reduction system, in accordance with an aspect of an exemplary embodiment;

FIG. 2 depicts a top view of the rotary wing aircraft of FIG. 1;

FIG. 3 depicts a block diagram illustrating an n/rev vibration reduction system, in accordance with an aspect of an exemplary embodiment;

FIG. 4 depicts a chart comparing n/rev vibrations before adding tail actuators;

FIG. 5 depicts a chart illustrating a reduction/ substantial elimination of tail vibrations as a result of n/rev vibration reduction system, in accordance with an aspect of an exemplary embodiment;

FIG. 6 depicts a side view of a rotary wing aircraft illustrating alternative positioning of active vibration control actuators of an n/rev vibration reduction system, in accordance with another aspect of an exemplary embodiment; and

FIG. 7 depicts a top view of the rotary wing aircraft of FIG. 6

### DETAILED DESCRIPTION

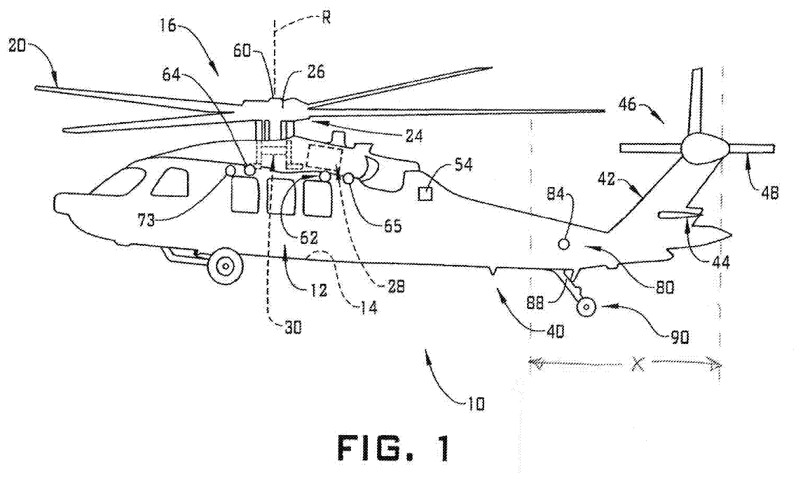

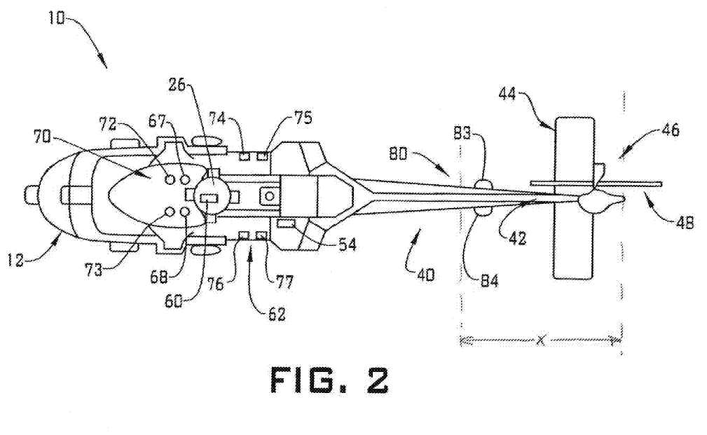

A vertical takeoff and landing (VTOL) or rotary wing aircraft, in accordance with an exemplary embodiment, is generally indicated at 10 in FIGS. 1 and 2. Rotary wing aircraft 10 including a fuselage 12 supported by an airframe 14. Rotary wing aircraft 10 includes a main rotor system 16, which rotates about a main rotor axis R. Main rotor system 16 includes a plurality of rotor blades 20 rotatable about a main rotor axis “R”. Plurality of rotor blades 20 is mounted to a rotor hub 24 having a rotor head 26. Main rotor system 16 is driven by a gearbox 28 coupled to one or more prime movers, indicated generally at 30.

Rotary wing aircraft 10 includes an extending tail 40 that supports a vertical stabilizer 42 and a horizontal stabilizer or stabilator 44. Extending tail 40 starts roughly aft of a cabin portion (not separately labeled) of aircraft 10 where fuselage 12 begins to narrow. A tail rotor system 46 including a plurality of tail rotor blades, indicated generally at 48 is mounted to vertical stabilizer 42. Tail rotor system 46 may be operatively coupled to gearbox 28 through a drive shaft (not shown). In an embodiment, rotary wing aircraft 10 includes an n/rev vibration reduction system 54 that operates to reduce vibrations that may be introduced into fuselage 12 and/or airframe 14 through operation of main rotor system 16.

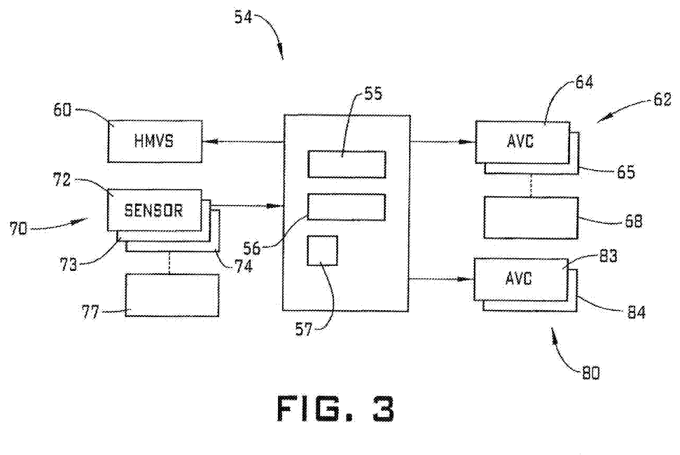

In accordance with an exemplary aspect depicted in FIG. 3, n/rev vibration reduction system 54 includes a controller or CPU 55 operatively connected to a non-volatile memory 56 and an actuator control module 57. It should be understood that while shown co-arranged at n/rev vibration reduction system 54, CPU 55, non-volatile memory 56 and actuator control module 57 may be located at different portions of rotary wing aircraft 10.

In an embodiment, a hub mounted vibration suppressor (HMVS) system 60 is mounted to rotor head 26 and operatively connected to n/rev vibration reduction system 54. N/rev vibration reduction system 54 is also operatively connected to a first plurality of active vibration control (AVC) actuators 62 that may include a first AVC actuator 64, a second AVC actuator 65, third and fourth actuators not shown) arranged on an opposing side of rotary wing aircraft 10, a fifth AVC actuator 67, and a sixth AVC actuator 68 that may be mounted to airframe 14 at various locations about fuselage 12.

For example, four of the plurality of AVC actuators 62 (e.g., first-fourth AVC actuators) may be arranged proximate to gearbox 28 on a gearbox mount (not shown), and fifth and sixth AVC actuators 67 and 68 may be arranged near the gearbox mount in an overhead of rotary wing aircraft 10 thereby addressing all six degrees of freedom (Fₓ, F_{y}, F_{z} and Mₓ, M_{y} and M_{z}) of gearbox 28. N/rev vibration reduction system 54 is also operatively coupled to a plurality of sensors 70 that may include a first sensor 72, a second sensor 73, a third sensor 74, a fourth sensor 75, a fifth sensor 76, and a sixth sensor 77 that may be mounted to airframe 14 at various locations about fuselage 12 provide six degree of freedom vibration information to n/rev vibration reduction system 54. It should be understood that the number and position of the sensors may vary.

In further accordance with an exemplary embodiment, rotary wing aircraft 10 includes a second plurality of AVC actuators 80 arranged on the extending tail 40. In an exemplary aspect, second plurality of AVC actuators 80 includes a first AVC actuator 83 and a second AVC actuator 84 mounted to opposing sides of extending tail 40 in a vibration affected zone “X”. Vibration affected zone “X” extends from about an upper edge (not separately labeled) of a trailing edge (also not separately labeled) of vertical stabilizer 42 forward a distance of about 0% to about 20% of a length of extending tail 40. In an exemplary aspect, first AVC actuator 83 and second AVC actuator 84 are mounted to opposing sides of extending tail 40 within about 15% of this distance. As shown, first and second AVC actuators 83, 84 may be mounted to opposing sides of extending tail 40 substantially vertically above a support 88 for a tail wheel 90.

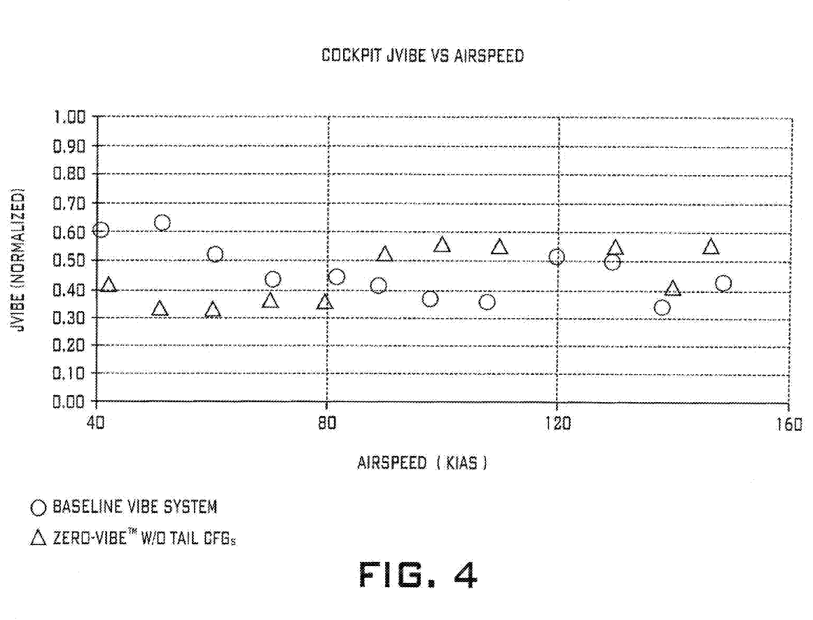

In operation, n/rev vibration reduction system 54 operates HMVS 60 to reduce and/or substantially attenuate large vibration loads, such as in-plane loads that rotor blades 20 exerts on the rotor hub 24. For example, HMVS 60 may account for two of the multiple degrees of freedom. N/rev vibration reduction system 54 also eliminates and/or substantially reduces multiple degrees of freedom caused by vibrations transmitted through gearbox 28 and by wake produced by rotor blades 20 impacting surfaces of extending tail 40. Test data, which depict n/rev vibrations before an implementation of tail vibration reduction is depicted in FIG. 4.

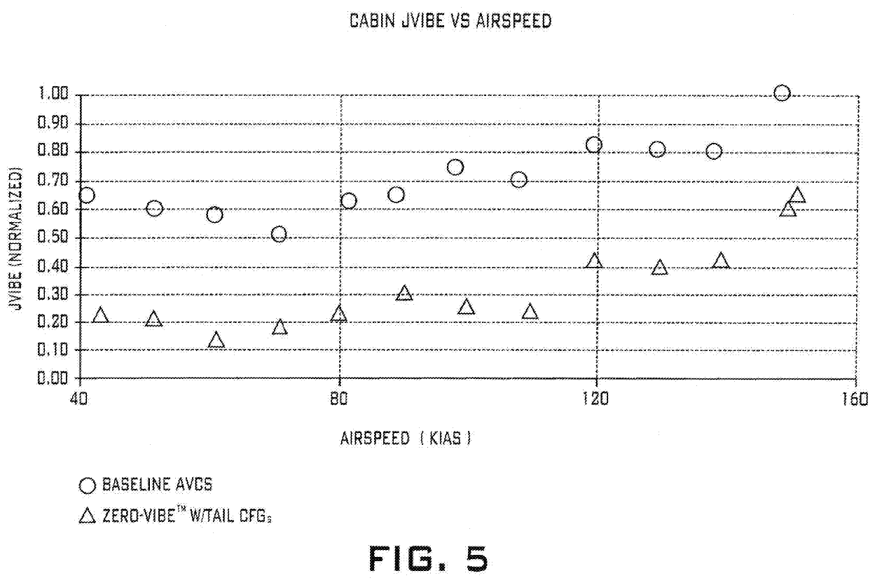

Once n/rev vibration reduction system 54 is active, vibration reduction is achieved such as shown in FIG. 5. As shown, the use of the vibration reduction system 54 on the extending tail 40 reduces the Jvibe to levels below a baseline bifilar and active vibration control system (AVCS) for all knots indicated airspeeds (KIAS), whereas a zero vibration system without the vibration reduction system 54 engaged matches or is out performed by the baseline bifilar and AVCS starting at roughly 60 KIAS.

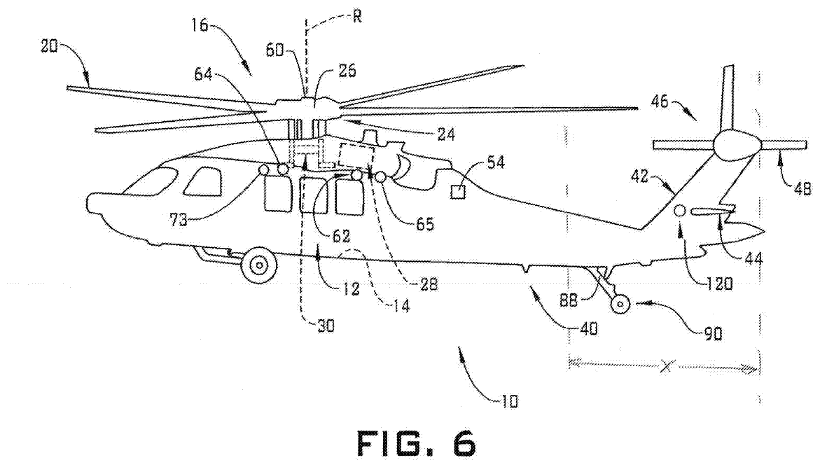

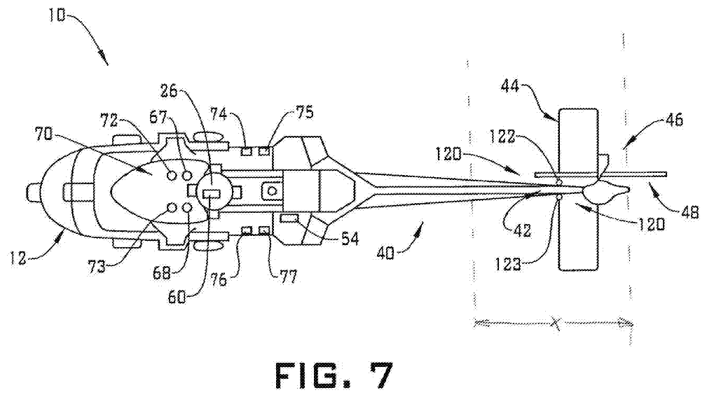

It should be understood that AVC actuators may be located at other positions on extending tail 40 within vibration affected zone “X” depending on rotor wake effects. For example, a second plurality of AVC actuators 120 including a first AVC actuator 122 and a second AVC actuator 123 may be mounted to opposing sides of extending tail 40 directly at vertical stabilizer 42 and/or stabilator 44 such as shown in FIG. 6 and FIG. 7, wherein like reference numbers represent corresponding parts in the respective views.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A vibration suppression system for a rotorcraft having an airframe, a main gear box, a rotor, a hub, a rotor head, and an extending tail including a vertical stabilizer and a stabilator, the vibration suppression system comprising:
one or more active vibration control actuators (AVC) mounted in the extending tail within a vibration affected zone, the vibration affected zone being between about 0% to about 20% of a length of the extending tail measured from a trailing edge of the vertical stabilizer.

2. The vibration suppression system according to claim 1, wherein the vibration affected zone is within about 0% to about 15% of the length of the extending tail measured from the trailing edge of the vertical stabilizer.

3. The vibration suppression system of claim 1, wherein the rotorcraft includes a wheel mounted to the extending tail, vibration affected zone extends from the trailing edge to substantially vertically above the wheel.

4. The vibration suppression system according to claim 3, wherein a first one of the one or more active vibration control actuators is mounted to a first side of the extending tail vertically above the wheel and a second one of the one or more active vibration control actuators is mounted to a second, opposing side of the extending tail vertically above the wheel.

5. The vibration suppression system according to claim 1, wherein at least one of the one or more AVC actuators is mounted to one of the vertical stabilizer and the stabilator.

6. The vibration suppression system of claim 1, further comprising: a hub mounted vibration suppressor (HMVS) mounted on the rotor head to reduce in-plane loads that the rotor exerts on the hub.

7. The vibration suppression system of claim 6, wherein the HMVS includes a plurality of hub actuators.

8. The vibration suppression system of claim 7, further comprising: a plurality of sensors for providing feedback to the plurality of hub actuators and the one or more active vibration control actuators.

9. The vibration suppression system of claim 8, wherein each of the plurality of sensors are mounted in a fuselage of the airframe.

10. The vibration suppression system of claim 9, wherein each of the plurality of sensors are accelerometers.

11. The vibration suppression system of claim 8, wherein the HMVS includes HMVS sensors operationally independent of the plurality of sensors.

12. The vibration suppression system of claim 6, further comprising:
a controller providing coordinated control information to both the HMVS and the one or more AVC actuators to reduce vibration.

13. The vibration suppression system of claim 12, wherein the HMVS includes an HMVS controller operational independent of the controller.

14. An aircraft comprising:
an airframe;
a main gear box;
a rotor including a hub and a rotor head;
an extending tail including a vertical stabilizer and a stabilator; and
one or more active vibration control actuators mounted in the extending tail within a vibration affected zone, the vibration affected zone being between about 0% to about 20% of a length of the extending tail measured from a trailing edge of the vertical stabilizer.

15. The aircraft according to claim 14, wherein vibration affected zone is within about 0% to about 15% of the length of the extending tail measured from the trailing edge of the vertical stabilizer.
